(19) United States
(12) Patent Application Publication
(10) Pub. No.: US 2006/0131826 A1
(43) Pub. Date: Jun. 22, 2006

(54) Removable wheel system

(76) Inventors: Von Schonblom, Snohmish, WA (US); Jeff Houkal, Bellevue, WA (US)

Correspondence Address: MILLER NASH LLP, 4400 TWO UNION SQUARE, 601 UNION STREET, SEATTLE, WA, 98101-2352, US

(21) Appl. No.: 11/312,798

(22) Filed: Dec. 20, 2005

Related U.S. Application Data
(60) Provisional application No. 60/637,683, filed on Dec. 20, 2004.

(51) Int. Cl. B62M 1/00

(52) U.S. Cl. 280/87.042

(57) ABSTRACT

The present invention is directed to devices having wheels, and specifically, a method and device for making the wheels easily detachable and interchangeable.

### CROSS-REFERENCE TO RELATED APPLICATION

This application claims priority from U.S. Provisional Application No. 60/637,683, filed on Dec. 20, 2004. The benefit of the filing date of the provisional application is hereby claimed, and the disclosures of the provisional application hereby incorporated herein by reference.

### BACKGROUND OF INVENTION

The present invention is directed to devices having wheels, and specifically, a method and device for making the wheels easily detachable and interchangeable.

### BRIEF DESCRIPTION OF THE DRAWINGS

FIG. 1 is an isometric view of the hangar assembly with the left wheel assembly shown as an exploded view.

FIG. 2 is a section view of the hangar assembly.

FIG. 3 shows the system mounted to a skateboard deck via a base-plate.

### DETAILED DESCRIPTION OF THE PREFERRED EMBODIMENT

The present invention is directed to devices having wheels, and specifically, a method and system for making the wheels of a device easily detachable and interchangeable.

The removable wheel system 10 may be used in connection with any device incorporating wheels. Without limiting the scope of the invention, exemplary devices with which the removable wheel system 10 may be used include, but are not limited to a skateboard, skates, wheelchairs, automobiles, trailers and tractors. However, for purposes of this detailed description, the removable wheel system 10 will be described and shown as used in connection with a skateboard.

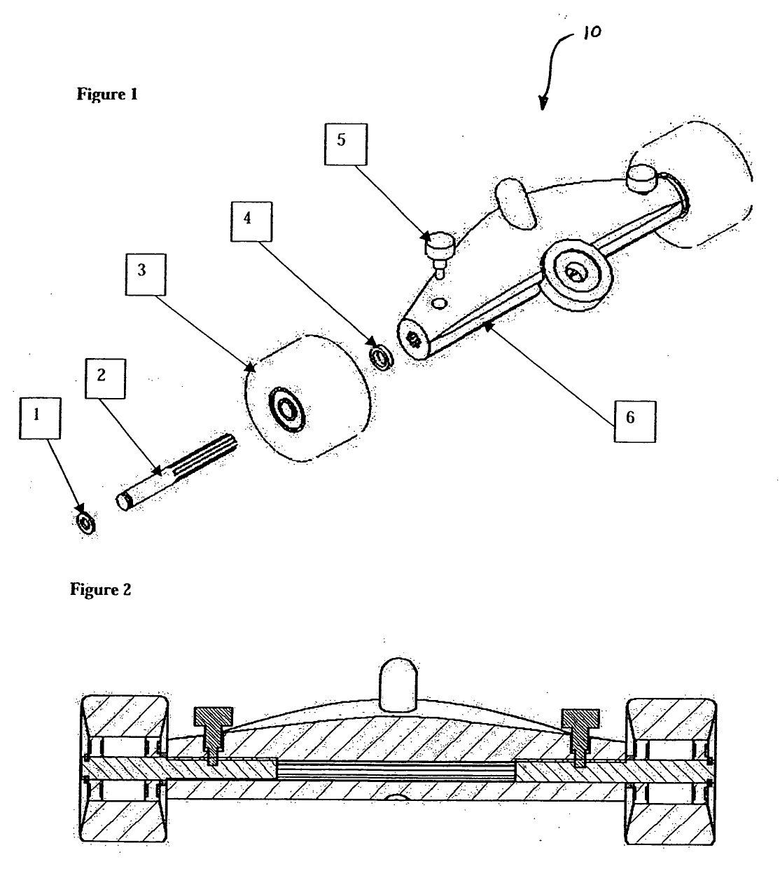

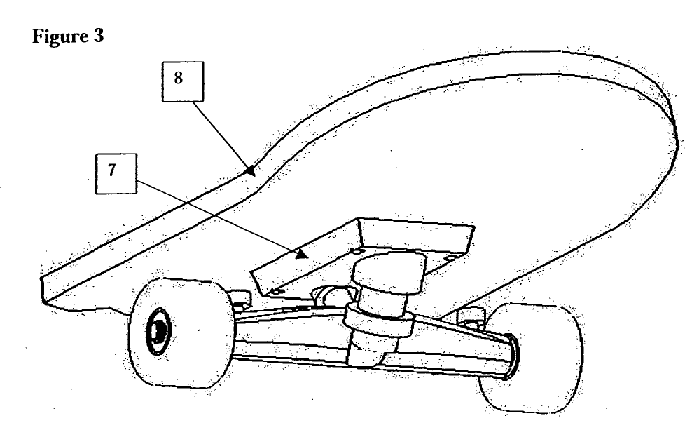

Referring to FIG. 1, the removable wheel system 10 includes a hangar assembly 6, wheel assembly 3, axle 2 and fastening mechanism 5. As shown in FIG. 2, the wheel assembly 3 may include an optional retaining clip 1 and optional bushing 4. The optional retaining clip 1, axle 2, wheel assembly 3, and optional bushing 4 are preferably removed along the hangar assembly's 6 axis. The system 10 shown in FIG. 1 is symmetrical about a centre line and the opposed side is preferably identical to the side shown in FIG. 1. Thus, when the removable wheel system 10 is discussed in relation to only one side, it can be appreciated that the second side is identical to the first but on the opposite side of the hangar assembly 6. An exemplary use of two systems 10 is shown in FIG. 3.

The wheel bearing assembly 3 is preferably removably connected to the hangar assembly 6 by the axle 2. The axle 2, is removably connected to the hangar assembly 6 by the fastening mechanism 5.

The fastening mechanism 5 is preferably removed perpendicular to the hangar assembly 6 axis. As shown in FIG. 1, the fastening mechanism 5 may be a fastener removably connected to the axle 2 and hangar assembly 6. The fastener operates to removably connect the axle 2 to the hangar assembly 6. FIG. 1 shows a fastener, but it should be understood that any removably connecting mechanism, such as a fastener, pin, or integrated “head” may be used.

The fastening mechanism 5 may be actuated by using either a push or pull action. The pull action may be manufactured to positively lock in the open position or spring back to the normal position once released. The pull option is preferably a pre-formed piece such as a fastener. The push option can either positively lock in the open position or spring back to the normal position once pressure is released. An electric or motorized fastener may be used, whereby a motor or solenoid performs the push or pull action.

The axle 2, which may be a spline, is preferably manufactured from material that will not be sheared from the load applied by the skateboard. Although the axle 2 may be uniformly shaped, in an optional embodiment, the axle 2 is composed of a first and second section. The first section of the axle 2 is situated within the wheel assembly 3, and is preferably regularly shaped. The end of the first section of the axle 2 preferably contains a mechanism, such as the retaining clip 1 shown in FIG. 1, to retain the wheel on the axle 2. The end of the first section of the axle 2 may further optionally include a hub cap. The second section of the axle 2 is situated within the hangar assembly 6. The second section of the axle 2 is preferably irregularly shaped in a manner to prevent rotation of the axle 2 within the hangar assembly 6. Exemplary shapes of the second section of the axle 2 may include, but are not limited to a star, hex, keyed, rectangular, or any other toothed shape which is extruded the length of the second section of the axle 2.

At some point in the axle, and in the case of the optional embodiment, the second section of the axle 2, there is an opening, hole, aperture, boss or groove by which the fastening mechanism 5 is able to removably connect to the axle 2, which in turn, removably connects the axle 2 to the hangar assembly 6.

The wheel assembly 3 may include any type of wheel commonly used in the industry. The wheel may be manufactured from any material commonly used in the industry. The wheel assembly 3 may optionally include captive bearings, and again, may be any bearing commonly used in the industry. The wheel bearings may be manufactured from any material including, but not limited to metal or plastic, and may consist of an outer and inner race along with ball or cylinder bearings arranged annularly between the races.

The hangar assembly 6 may be a metal or composite structure, or a combination thereof, that can be either solid or sectionally assembled. It has a feature extruded along it's axis that accepts the axle 2. The hangar assembly 6 preferably includes an opening whereby the fastening mechanism 5 may be removably connected to the hangar assembly 6, either by press fit or by fastener.

If using the removable wheel system 10 with a skateboard, it is preferred that the hangar assembly 6 be attached to a base-plate 7 so it may pivot about the base-plate's 7 center. The base-plate 7 is preferably attached to the deck of the skateboard 8.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A removable wheel system comprising:
a hangar assembly comprising
a hangar base;
a first opening at an end of said hangar base; and
a second opening through said hangar base and perpendicular to said first opening;
a wheel assembly;
an axle having an opening through said axle;
wherein the axle is removably inserted through an opening of said wheel assembly and said first opening of said hangar base;
an attachment mechanism; and
whereby said axle is removably connected to said hangar assembly by removably inserting said attachment mechanism through said second opening of said hangar base and said opening of said axle.

2. A skateboard having quick release, detachable wheels, said skateboard comprising:
a deck
a first wheel base for the front hangar assembly and a second wheel base for the rear hangar assembly
a first and second detachable axles mounted to said first and second hangar assemblies
wheel hubs detachably connected to said wheel bases and rotatable therewith and wheels mounted on said wheel hubs and rotatable therewith.

3. The skateboard of claim 2, said first and second detachable axles mounted to said first and second hangar assemblies using a spline.

4. The skateboard of claim 3, said spline is formed from a hard material designed to prevent shearing from the load applied by the skateboard.

5. The skateboard of claim 3, said spline being smooth and cylindrical for the bearings to ride on.

6. The skateboard of claim 3, said spline having, at one end, a means to retain the wheel.

7. The skateboard of claim 3, said spline having a means to prevent rotation of the spline assembly.

8. The skateboard of claim 7, said means to prevent rotation of the spline being a star, hex, keyed, rectangular, or any other toothed shape that is extruded the length of section.

9. The skateboard of claim 3, said spline having, at one point, a structure that the fastening mechanism engages with to prevent pull out of the wheel.

10. The skateboard of claim 2, said hangar is made of a metal or composite structure.

11. The skateboard of claim 10, said hangar can be either solid or sectionally assembled.

12. The skateboard of claim 10, said hangar having a feature extruded along its axis that accepts the spline.

13. The skateboard of claim 10, said hangar having a means to hold the fastening mechanism, either by press fit or by fastener.

14. The skateboard of claim 10, said hangar being attached to the base-plate such that it can pivot about the base-plate's center.

15. The skateboard of claim 2, said base-plate is attached rigidly to the deck and can be removed by removing the fasteners.

16. A detachable wheel assembly having a quick release for each wheel, said wheel assembly comprising:
a wheel base
a hangar assembly
detachable axles mounted to said hangar assembly
wheel hubs detachably connected to said wheel base and rotatable therewith and wheels mounted on said wheel hubs and rotatable therewith.

17. The wheel assembly of claim 16, said detachable axles are mounted to said hangar assembly using a spline.

18. The wheel assembly of claim 16, said spline is formed from a hard material designed to prevent shearing from the load applied by the skateboard.

19. The wheel assembly of claim 16, said spline being smooth and cylindrical for the bearings to ride on.

20. The wheel assembly of claim 16, said spline having, at one end, a means to retain the wheel.

21. The wheel assembly of claim 16, said spline having a means to prevent rotation of the spline assembly.

22. The wheel assembly of claim 21, said means to prevent rotation of the spline being chosen from a group consisting of a star, hex, keyed, rectangular, toothed and any other irregular shape that is extruded the length of section.

23. The wheel assembly of claim 16, said spline having, at one point, a structure that the fastening mechanism engages with to prevent pull out of the wheel.

24. The wheel assembly of claim 16, said hangar is made of a metal or composite structure.

25. The wheel assembly of claim 16, including a base plate, said base-plate having attachment points for attaching to a skateboard deck, said attachment points can be opened by removing the fasteners.

26. The wheel assembly of claim 16, at least one end of said spline including means to attach a hubcap.
